(19) United States
(12) Patent Application Publication
(10) Pub. No.: US 2020/0290486 A1
(43) Pub. Date: Sep. 17, 2020

(54) RECLINER SHAFT FOR VEHICLE SEAT

(71) Applicant: Kuk-Tae SUNG, Chungcheongnam-do (KR)

(72) Inventor: Kuk-Tae SUNG, Chungcheongnam-do (KR)

(21) Appl. No.: 16/815,263

(22) Filed: Mar. 11, 2020

Related U.S. Application Data
(60) Provisional application No. 62/817,154, filed on Mar. 12, 2019.

(51) Int. Cl. B60N 2/225

(52) U.S. Cl. CPC B60N 2/225; F16C 2226/80

(57) ABSTRACT

A recliner shaft includes first parts which are spaced apart from each other and form portions of a cylindrical shape, and second parts connecting the first parts and formed so as to form protrusions by protruding outward from the cylindrical shape. The second parts include a first spline protrusion and a second spline protrusion which have the same shape, and are disposed to be symmetrical with respect to a virtual straight line passing through a center of the cylindrical shape.

### CROSS-REFERENCE TO RELATED APPLICATION(S)

This application claims the benefit of U.S. Provisional Patent Application No. 62/817,154 filed on Mar. 12, 2019, the entire disclosures of which are incorporated herein by reference for all purposes.

### BACKGROUND

### 1. Technical Field

Exemplary embodiments of the inventive concept relate to a recliner shaft. More particularly, exemplary embodiments of the inventive concept relate to a recliner shaft for a vehicle seat capable of rotating and fixing a seat back thereof with desired angel.

### 2. Description of the Related Art

For a vehicle seat on which a driver or passenger of a vehicle seats, a recliner is installed to adjust an angle of a seat back and a seat cushion back and forth, so that the driver or passenger of the vehicle can be kept in a suitable position for driving or can be adjusted to any desired angle.

Two recliners are installed at both ends of hinge-combining-portion of a cushion frame on which the seat cushion is installed and a seatback frame on which the seat back is installed, and the recliners at the both ends are connected to each other by a recliner shaft.

The driver or passenger can adjust the angle of the seat back by operating the recliner manually or automatically by rotating the recliner shaft. When the recliner shaft rotates, the seat back rotates forward or backward with respect to the seat cushion.

However, traditional recliner shaft is formed by a round bar in which is fully closed, so that there is a problem with heavy weight, accordingly, this is one factor that cannot meet a trend of lightening of a vehicle and increases a manufacturing cost as a whole.

### SUMMARY

One or more exemplary embodiment of the inventive concept provides a recliner shaft with a hollow pipe form.

One or more exemplary embodiments of the inventive concept also provide a recliner shaft capable of maintaining a sufficient torsional strength while reducing a weight and manufacturing cost by forming a hollow therein.

According to an exemplary embodiment of the inventive concept, a recliner shaft includes first parts which are spaced apart from each other and form portions of a cylindrical shape, and second parts connecting the first parts and formed so as to form protrusions by protruding outward from the cylindrical shape. The second parts include a first spline protrusion and a second spline protrusion which have the same shape, and are disposed to be symmetrical with respect to a virtual straight line passing through a center of the cylindrical shape.

In an exemplary embodiment, the second parts may further include a third spline protrusion and a fourth spline protrusion which are disposed on the virtual straight line.

In an exemplary embodiment, the third spline protrusion and the fourth spline protrusion may have the same shape.

In an exemplary embodiment, the third spline protrusion and the first spline protrusion may have the same shape.

In an exemplary embodiment, the third spline protrusion and the fourth spline protrusion may be spaced apart each other and disposed at a predetermined angle along a circumferential direction of the cylindrical shape. The fourth spline protrusion and the first spline protrusion may be spaced apart each other and disposed at an angle which is greater than the predetermined angle along the circumferential direction of the cylindrical shape.

In an exemplary embodiment, a length of an outer circumferential surface of the fourth spline protrusion may be greater than a length of an outer circumferential surface of the third spline protrusion.

In an exemplary embodiment, the fourth spline protrusion may include a first curved surface portion in contact with a virtual circle having a center as the center of the cylindrical shape, and a second curved surface portion having a center of curvature at a point outside the cylindrical shape and curved at a predetermined curvature.

According to the recliner shaft for a vehicle seat according to the present invention, a hollow pipe hollow recliner shaft is provided, thereby contributing to weight saving of the vehicle and reducing manufacturing cost.

In addition, the recliner may have a hollow pipe shape, and sufficient torsional strength is maintained with light weight to transmit rotational force to a recliner device.

It is to be understood that both the foregoing general description and the following detailed description are exemplary and explanatory and are intended to provide further explanation of the invention as claimed.

### BRIEF DESCRIPTION OF THE DRAWINGS

The above and other features of the inventive concept will become more apparent by describing in detail exemplary embodiments thereof with reference to the accompanying drawings, in which:

FIG. 1 is a perspective view illustrating a recliner shaft according to an exemplary embodiment of the inventive concept;

FIG. 2 is a cross-sectional illustrating a recliner shaft according to an exemplary embodiment of the inventive concept;

FIG. 3 is a perspective view illustrating a recliner shaft according to another exemplary embodiment of the inventive concept;

FIG. 4 is a cross-sectional illustrating a recliner shaft according to another exemplary embodiment of the inventive concept;

FIG. 5 is a perspective view illustrating a recliner shaft according to still another exemplary embodiment of the inventive concept;

FIG. 6 is a cross-sectional illustrating a recliner shaft according to still another exemplary embodiment of the inventive concept;

FIG. 7 is a conceptual view illustrating an enlarged view of the fourth spline protrusion of FIG. 6; and

FIG. 8 is a use state view of a recliner shaft according to an exemplary embodiment of the inventive concept.

### DETAILED DESCRIPTION

Hereinafter, the inventive concept will be explained in detail with reference to the accompanying drawings.

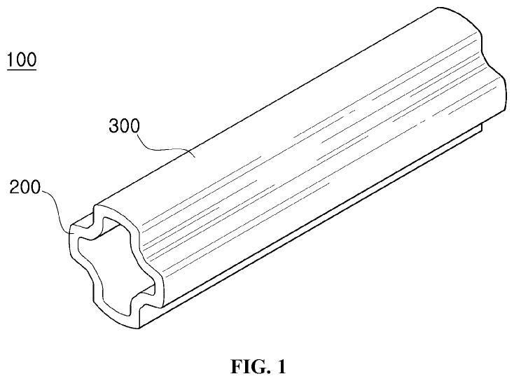

FIG. 1 is a perspective view illustrating a recliner shaft according to an exemplary embodiment of the inventive concept.

Referring to FIG. 1, a recliner shaft 100 has a cylindrical shape including a plurality of protrusions protruding toward outside. More specifically, the recliner shaft 100 includes first parts I forming portions of the cylindrical shape, and second parts II connecting the first parts I.

The first parts I are spaced apart from each other so that the recliner shaft 100 has the cylindrical shape formed so as to be cut off in the middle. The second parts II are disposed between the first parts I to connect the first parts I. In addition, the second parts II are formed so as to form spline protrusions 300 by protruding outward from the cylindrical shape formed by the first parts I.

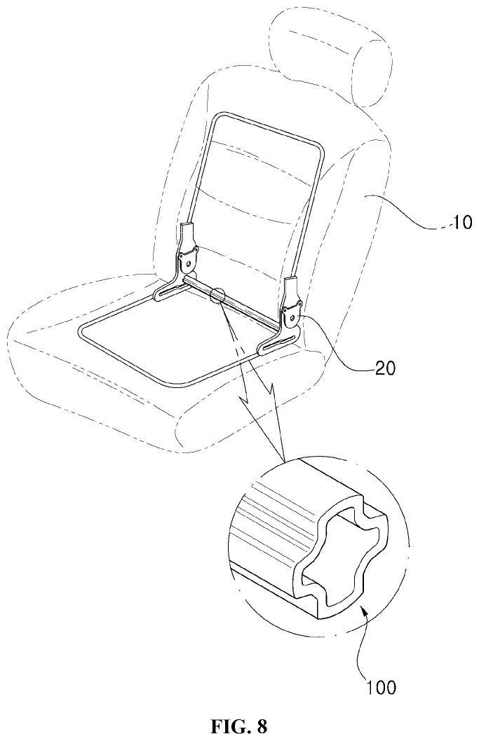

The second part II may transmit a rotational force by being caught in a spline groove of the recliner device 20. In other words, the second parts II are formed so as to be engaged with the spline grooves (not shown) formed in the recliner device 20 by taking the shape of the spline protrusions 300 protruding out of the cylindrical shape. The second parts II engaged in the spline grooves when the recliner shaft 100 rotates may transmit torque to the recliner device 20 (refers to FIG. 8).

Referring to FIG. 1, the plurality of spline protrusions 300 are spaced apart from each other along a circumferential direction of a body 200 to form four spline protrusions 300.

The recliner shaft 100 has a shape in which a cross section of a specific shape is elongated in one direction. According to the figures, the second parts II and the first parts I extend in a straight line in a longitudinal direction of the recliner shaft 100. In the figures, both ends of the recliner shaft 100 are shown to have the same shape, but according to another embodiment, both ends may be formed to have different shapes.

A hollow is formed inside the recliner shaft 100. In other words, the recliner shaft 100 has a pipe shape with a hole in the center.

The hollow of the recliner shaft 100 may have a specific shape. For example, in the center of the hollow, a virtual circle having a certain radius may be drawn with respect to a center M1 of the body 200, and a hollow protrusion in which a portion of a circumference of the virtual circle ‘a’ protrudes to the outside can be formed.

The hollow protrusion may have a virtual rectangular shape having a curvature at an edge as shown in the figures. In addition, according to another embodiment of the present invention, the hollow protrusions may be formed to have a virtual circular, semicircular or elliptic shape.

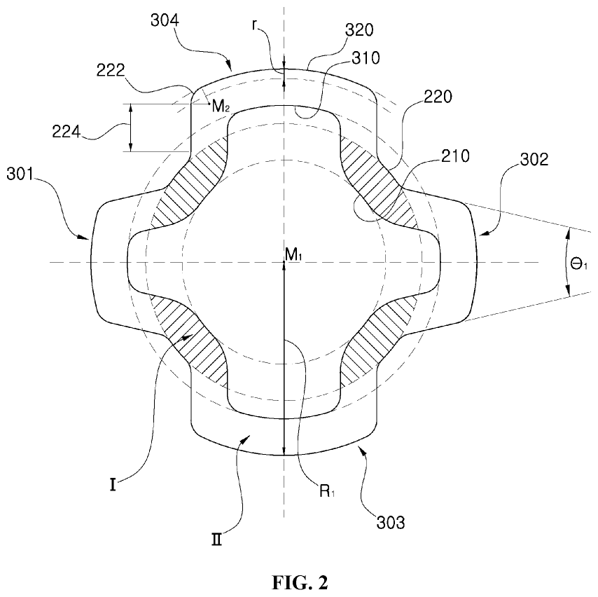

FIG. 2 is a cross-sectional illustrating a recliner shaft according to an exemplary embodiment of the inventive concept.

Referring to FIG. 2, the recliner shaft 100 includes a plurality of spline protrusions 300. The spline protrusions 300 are disposed to be spaced apart from each other along the circumferential direction of the body 200. As shown in the figures, each spline protrusion 300 is spaced apart by 90 [deg.]

Hereinafter, for convenience of explanation, the spline protrusion in a left side in the figure is referred to as a first spline protrusion 301, and the spline protrusion in a right side in the figure is referred to as a second spline protrusion 302.

The spline protrusion in a lower side in the figure is referred to as a third spline protrusion 303, and the spline protrusion in an upper side in the figure is referred to as a fourth spline protrusion 304.

As described in the figure, the first spline protrusion 301 and the second spline protrusion 302 are formed to be symmetrical with respect to the center M1 of the body and the third spline protrusion 303. The fourth spline protrusion 302 and the spline protrusions 304 are formed to be symmetrical to each other.

Here, the first spline protrusion 301 and the second spline protrusion 302, the second spline protrusion 302 and the third spline protrusion 303, the third spline protrusion 303 and the fourth spline protrusion 304, the spline protrusion 304 and the first spline protrusion 301 are spaced apart from each other at the same 90 degree intervals with respect to the center M1 of the body 200. As described in the figure, the first spline protrusion 301 and the second spline protrusion 302 have the same shape, and the third spline protrusion 303 and the fourth spline protrusion 304 have the same shape, but according to another embodiment, the spline protrusions may have the same shape or all the spline protrusions may have different shapes.

The recliner shaft 100 may be divided into first parts I constituting portions of a cylindrical shape and second parts II connecting the first parts I for convenience of explanation.

For example, a portion forming the body 200 of the recliner shaft 100 may be referred to as the first part I, and a portion where the spline protrusion 300 is formed may be referred to as the second part II.

An inner circumferential surface connecting portion and an outer circumferential surface connecting portion are formed between the spline protrusion 300 and the body 200.

The inner circumferential surface connection portion connects an inner circumferential surface 310 of the spline protrusion 300 and an inner circumferential surface 210 of the body 200. The outer circumferential surface connecting portion connects an outer circumferential surface 320 of the spline protrusion 300 and an outer circumferential surface 220 of the body 200.

As shown, a curved surface portion 222 is formed at an end of the outer circumferential surface 320 of the spline protrusion 300. The curved surface portion 222 curves with a predetermined curvature with respect to a curvature center M2. An extended portion 224 extending toward the outer circumferential surface 220 of the body 200 is formed at one end of the curved surface portion 222. The curved surface portion 222 is formed so as to occupy a thickness of ‘r’ at the spline protrusion 300.

The spline protrusions 300 may be formed to have a constant inclination. For example, as shown in the figure, both sides of the spline protrusion 302 may be inclined so as to have an angle of θ1 with respect to each other.

As a specific example of the present invention, when a diameter of the outer circumferential surface 220 of the body 200 is 7.6, a diameter of the outer circumferential surface 320 of the spline protrusion 300 is 10.6. At this time, a width of the fourth spline protrusion 304 is 5.1 and a radius of the first curved portion is 0.5. The thickness ‘r’ is 0.05 times the diameter of the outer peripheral surface 320 of the spline projection 300. The θ1 is 26 degrees.

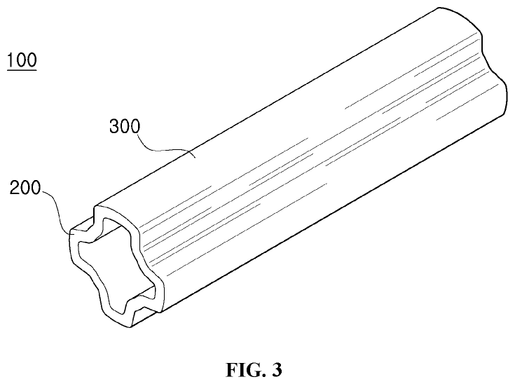

FIG. 3 is a perspective view illustrating a recliner shaft according to another exemplary embodiment of the inventive concept.

Referring to FIG. 3, a plurality of spline protrusions 300 are spaced apart from each other along a circumferential direction of a body 200 to form four spline protrusions 300. At this time, at least one of the four spline protrusions 300 may have a different shape. For example, as shown in the figure, an upper protrusion may be formed larger than the other protrusions, or a lower protrusion may be formed smaller than the other protrusions.

The recliner shaft according to the present embodiment has a shape in which a cross section of a specific shape is elongated in one direction like the recliner shaft shown in FIG. 1. As shown, second parts II and first parts I extend in a straight line in a longitudinal direction of the recliner shaft 100. In the figures, both ends of the recliner shaft 100 are shown to have the same shape, but according to another embodiment, both ends may be formed to have different shapes.

A hollow is formed inside the recliner shaft 100. In other words, the recliner shaft 100 has a pipe shape with a hole in the center.

The hollow of the recliner shaft 100 may have a specific shape. For example, in the center of the hollow, a virtual circle having a certain radius may be drawn with respect to a center M1 of the body 200, and a hollow protrusion in which a portion of a circumference of the virtual circle ‘a’ protrudes to the outside can be formed.

The hollow protrusion may have a virtual rectangular shape having a curvature at an edge as shown in the figures. In addition, according to another embodiment of the present invention, the hollow protrusions may be formed to have a virtual circular, semicircular or elliptic shape.

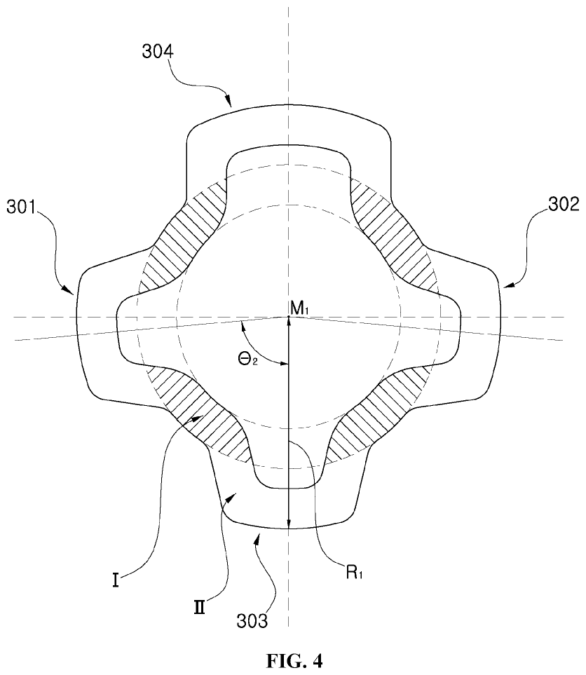

FIG. 4 is a cross-sectional illustrating a recliner shaft according to another exemplary embodiment of the inventive concept.

According to the present embodiment, at least one of four spline protrusions may have a different shape. That is, as illustrated, the fourth spline protrusion 304 may be formed to be larger than the first, second and third spline protrusions. A length of an outer circumferential surface of the fourth spline protrusion 304 is formed to be larger than length of outer circumferential surfaces of the other spline protrusions.

Referring to FIG. 4, angle θ2 between the first spline protrusion 301 and the third spline protrusion 303 is smaller than 90 [deg.] and angle between the first spline protrusion 301 and the fourth spline protrusion 304 is smaller than 90 [deg.] In other words, the first spline protrusion 301 and the second spline protrusion 302 are slightly moved toward the third spline protrusion 303 while the fourth spline protrusion 304 is formed larger than the other protrusions.

In this case, the first spline protrusion 301 and the second spline protrusion 302 are disposed to be symmetrical with respect to a virtual straight line passing through a center M1 of the cylinder shape. The third spline protrusion 303 and the fourth spline protrusion 304 are disposed on the virtual straight line. That is, a cross section of the recliner shaft is symmetrical to left and right in the figure.

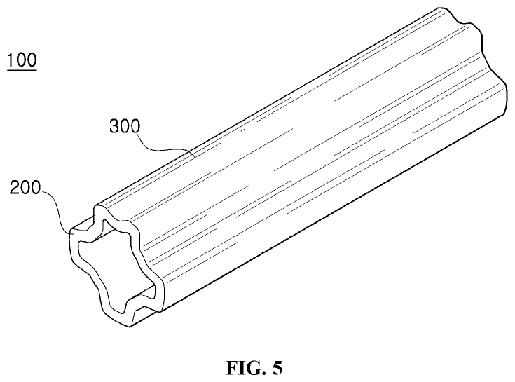

FIG. 5 is a perspective view illustrating a recliner shaft according to still another exemplary embodiment of the inventive concept.

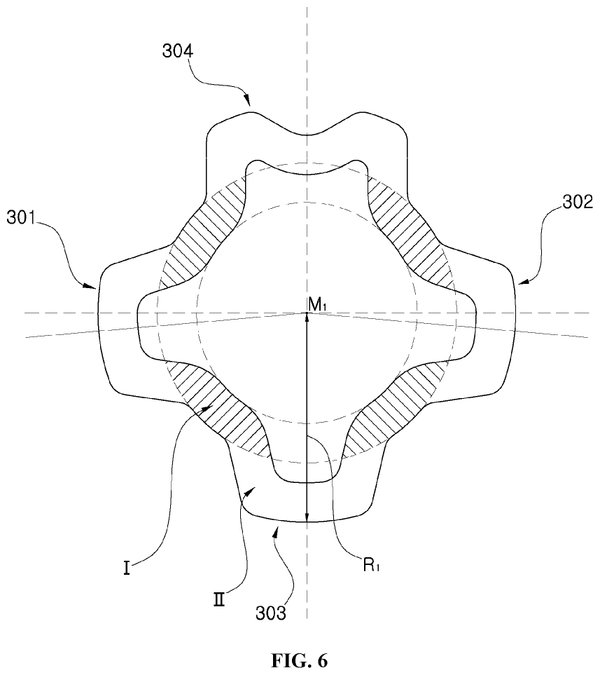

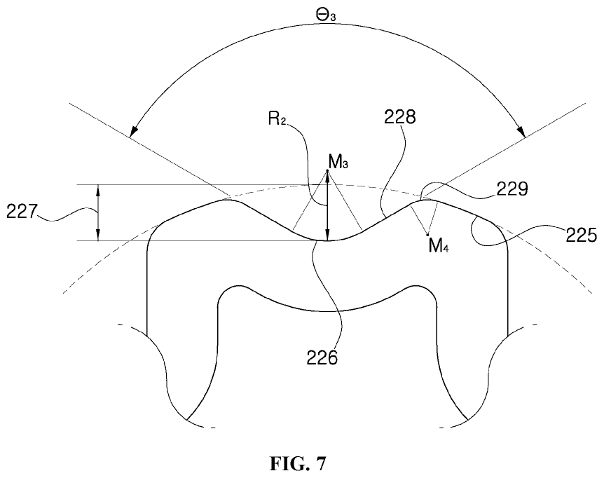

Referring to FIG. 5, a plurality of spline protrusions 300 are spaced apart from each other along a circumferential direction of a body 200 to form four spline protrusions 300. At this time, at least one of the four spline protrusions 300 may have a different shape. For example, an upper protrusion may be formed larger than the other protrusions, or a lower protrusion may be formed smaller than the other protrusions. Here, as shown, one of the spline protrusions may be formed with a recessed groove toward inside of the body. FIG. 6 is a cross-sectional illustrating a recliner shaft according to still another exemplary embodiment of the inventive concept. FIG. 7 is a conceptual view illustrating an enlarged view of the fourth spline protrusion of FIG. 6.

FIG. 6 shows an embodiment in which a shape of the fourth spline protrusion 304 is modified in the embodiment shown in FIG. 4.

Referring to FIGS. 6 and 7, the fourth spline protrusion 304 has the recessed groove which is recessed toward the center of the cylindrical shape. More specifically, an outer circumferential surface 320 of the fourth spline protrusion 304 includes a first curved surface portion 225 in contact with a virtual circle having a center as the center M1 of the cylindrical shape, and a second curved surface portion 226 having a center of curvature at a point outside the cylindrical shape and curved at a predetermined curvature.

A first extending portion 228 and a third curved portion 229 may be formed between the first curved surface portion 225 and the second curved surface portion 226. The first extending portion 228 is a plane connecting the second curved surface portion 226 and the third curved surface portion 229. The third curved surface portion 229 is formed to have a predetermined curvature with a point M4 as a center of curvature. Depth 22 of the recessed groove may be formed such that a distance between the outer circumferential surface 320 and the inner circumferential surface 310 of the spline protrusion is equal to a thickness of the cylindrical shape.

As a specific example of the present invention, when a diameter of the outer circumferential surface 320 of the fourth spline protrusion 320 is 10.6, the depth of the recessed groove is 0.8, the radius of the second curved surface 226 is 1, and the radius of the third curved surface 229 is 0.5. In this case, the angle θ3 of the recessed groove is 120 [deg.]

FIG. 8 is a use state view of a recliner shaft according to an exemplary embodiment of the inventive concept.

A spline protrusion 300 protruded from an outer circumferential surface of a recliner shaft 100 is engaged with a spline groove (not shown) of a recliner device 20 to transmit a rotational force of the recliner shaft 100 to the recliner device 20. At this time, since the spline protrusion 300 and a groove portion 400 are formed as described above, the recliner shaft 100 is formed in a hollow shape capable of reducing weight and material cost compared to conventional ones, and has enough strength capable of preventing a twist deformation.

The foregoing is illustrative of the inventive concept and is not to be construed as limiting thereof. Although a few exemplary embodiments of the inventive concept have been described, those skilled in the art will readily appreciate that many modifications are possible in the exemplary embodiments without materially departing from the novel teachings and advantages of the inventive concept. Accordingly, all such modifications are intended to be included within the scope of the inventive concept as defined in the claims. In the claims, means-plus-function clauses are intended to cover the structures described herein as performing the recited function and not only structural equivalents but also equivalent structures. Therefore, it is to be understood that the foregoing is illustrative of the inventive concept and is not to be construed as limited to the specific exemplary embodiments disclosed, and that modifications to the disclosed exemplary embodiments, as well as other exemplary embodiments, are intended to be included within the scope of the appended claims. The inventive concept is defined by the following claims, with equivalents of the claims to be included therein.

What is claimed is:

1. A recliner shaft, comprising:
first parts which are spaced apart from each other and form portions of a cylindrical shape; and
second parts connecting the first parts and formed so as to form protrusions by protruding outward from the cylindrical shape, the second parts comprising a first spline protrusion and a second spline protrusion which have the same shape, and are disposed to be symmetrical with respect to a virtual straight line passing through a center of the cylindrical shape.

2. The method of claim 1, wherein the second parts further comprise a third spline protrusion and a fourth spline protrusion which are disposed on the virtual straight line.

3. The method of claim 2, wherein the third spline protrusion and the fourth spline protrusion have the same shape.

4. The method of claim 2, wherein the third spline protrusion and the first spline protrusion have the same shape.

5. The method of claim 4, wherein the third spline protrusion and the fourth spline protrusion are spaced apart from each other and disposed at a predetermined angle along a circumferential direction of the cylindrical shape; and
the fourth spline protrusion and the first spline protrusion are spaced apart from each other and disposed at an angle which is greater than the predetermined angle along the circumferential direction of the cylindrical shape.

6. The method of claim 5, wherein a length of an outer circumferential surface of the fourth spline protrusion is greater than a length of an outer circumferential surface of the third spline protrusion.

7. The method of claim 6, wherein the fourth spline protrusion comprises a first curved surface portion in contact with a virtual circle having a center as the center of the cylindrical shape, and a second curved surface portion having a center of curvature at a point outside the cylindrical shape and curved at a predetermined curvature.
